(19) United States
(12) Patent Application Publication
(10) Pub. No.: US 2008/0145756 A1
(43) Pub. Date: Jun. 19, 2008

(54) ALKALINE STORAGE BATTERY

(76) Inventor: Akihiro TANIGUICHI, Hyogo (JP)

Correspondence Address: MCDERMOTT WILL & EMERY LLP, 600 13TH STREET, NW, WASHINGTON, DC, 20005-3096, US

(21) Appl. No.: 11/953,378

(22) Filed: Dec. 10, 2007

(30) Foreign Application Priority Data
Dec. 19, 2006 (JP) 2006-340840

(51) Int. Cl. H01M 6/00

(52) U.S. Cl. 429/206

(57) ABSTRACT

In an alkaline storage battery in which at least one selected from the group consisting of the separator surface, the positive electrode plate, and the negative electrode plate contains a metal compound, and at least one of the positive electrode plate and the negative electrode plate contains a leachable metal, the metal compound allows the leachable metal leached out into the alkaline electrolyte to be deposited on the separator surface, the surface or inside of the positive electrode plate, or the surface or inside of the negative electrode plate. This enables obtaining a long-life alkaline storage battery in which self discharge can be excellently curbed.

### FIELD OF THE INVENTION

The present invention relates to alkaline storage batteries, particularly to a nickel-metal hydride storage battery using a hydrogen storage alloy.

### BACKGROUND OF THE INVENTION

Recently, alkaline storage batteries are gaining attention as a power source for portable devices, electric vehicles, and hybrid electric vehicles. Also, with advancement of portable devices, alkaline storage batteries used as a power source are expected to perform better. Known examples of alkaline storage batteries include nickel-metal hydride storage batteries and alkaline-zinc storage batteries.

Particularly, nickel-metal hydride storage batteries are high in energy density, and are widely used as an excellently reliable secondary battery. Nickel-metal hydride storage batteries have a positive electrode containing nickel hydroxide and a negative electrode containing a hydrogen storage alloy. To the positive electrode, a metal such as cobalt is generally added along with nickel hydroxide, to increase conductivity of the positive electrode active material. For the negative electrode, a hydrogen storage alloy containing cobalt is generally used. A separator is interposed between the positive electrode and the negative electrode, to insulate the positive electrode and the negative electrode from contact. For the separator, nonwoven fabrics are used.

In alkaline storage batteries, repetitive charge and discharge cycles cause the negative electrode active material to deposit on the negative electrode surface, and the deposited material becomes a branched conductive material called dendrite. Dendrites grow and finally reach the positive electrode surface. As a result, an internal short-circuit occurs, declining charge and discharge efficiency of the active material, self discharge characteristics, and battery life. Therefore, in alkaline storage batteries for electric vehicles and hybrid electric vehicles such as nickel-metal hydride storage batteries, which are required to have long life, it is important to prevent the dendrite deposition, and to curb the decline in charge and discharge efficiency and self discharge characteristics.

Japanese Laid-Open Patent Publication No. 2006-73541 proposes an alkaline-zinc storage battery including a separator with a first film (alkali-resistant microporous film) facing the positive electrode and a second film (polyvinyl alcohol film) facing the negative electrode for the purpose of preventing the internal short-circuit occurrence due to dendrites. The first film contains a metal that oxidizes zinc (negative electrode active material) leached out from the negative electrode and makes it soluble to the electrolyte. Therefore, dendrite deposition is curbed. The polyvinyl alcohol film (second film) micronizes dendrites, to make the dendrite soluble to the electrolyte. Therefore, even if dendrites deposit, its growth is curbed. That is, by the separator including the first film and the second film, the dendrite deposition and growth are curbed, and the decline in self discharge characteristics of alkaline-zinc storage batteries is curbed.

In alkaline storage batteries, ions of a metal such as cobalt leached out from the positive electrode and the negative electrode deposit in the separator and form a conductive path. The present inventors found out that this conductive path is one of the causes of the decline in self discharge characteristics of alkaline storage batteries. The decline in self discharge characteristics is probably due to the fact that the deposited metal forms a conductive path in the separator.

Even by using the technique of Japanese Laid-open Patent Publication No. 2006-73541, ions of metals such as cobalt and manganese leached out from the positive electrode and the negative electrode deposit in the separator. Therefore, in the alkaline storage battery described in JP 2006-73541 as well, the decline in self discharge characteristics cannot be avoided.

### BRIEF SUMMARY OF THE INVENTION

The present invention aims to provide a long-life alkaline storage battery in which the decline in self discharge characteristics is curbed.

The present invention relates to an alkaline storage battery comprising:

a positive electrode plate;

a negative electrode plate;

a separator interposed between the positive electrode plate and the negative electrode plate; and an alkaline electrolyte,

wherein at least one of the positive electrode plate and the negative electrode plate contains a metal, the metal being capable of being leached out into the alkaline electrolyte,

at least one selected from the group consisting of the surface of the separator, the positive electrode plate, and the negative electrode plate contains a metal compound, and

the metal compound allows the metal leached out into the alkaline electrolyte from at least one of the positive electrode plate and the negative electrode plate to be deposited on the surface of the separator, the surface or inside of the positive electrode plate, or the surface or inside of the negative electrode plate.

The metal compound is preferably at least one selected from the group consisting of an aluminum oxide, a magnesium oxide, a nickel oxide, a zirconium oxide, a titanium oxide, an indium oxide, and a chromium hydroxide.

The metal compound is preferably carried on at least one of the positive electrode plate surface and the negative electrode plate surface.

When the positive electrode plate includes a positive electrode material mixture layer, the positive electrode material mixture preferably includes the metal compound along with the positive electrode active material and a binder.

When the negative electrode plate includes a negative electrode material mixture layer, the negative electrode material mixture preferably includes the metal compound along with the negative electrode active material and a binder.

The present invention achieves providing a long-life alkaline storage battery in which the decline in self discharge characteristics is curbed. The alkaline storage battery of the present invention can curb the deposition of the metal ion leached out from the positive electrode plate and the negative electrode plate into the separator. As a result, the formation of the conductive path in the separator can be curbed, and self discharge can be excellently curbed. Therefore, the alkaline storage battery of the present invention may be used suitably for, for example, a power source for portable devices, or electric vehicles and hybrid electric vehicles which are required to have long-life.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWING

FIG. 1 is a vertical cross section of a cylindrical alkaline storage battery of one embodiment of the present invention.

### DETAILED DESCRIPTION OF THE INVENTION

An alkaline storage battery of the present invention is characterized in that at least one of a positive electrode plate and a negative electrode plate contains a metal capable of being leached out into an electrolyte (hereinafter referred to as “leachable metal”). The alkaline storage battery of the present invention is also characterized in that a metal compound is included in at least one selected from the group consisting of a separator surface, a positive electrode plate, and a negative electrode plate. The metal forming the metal compound and the leachable metal are of different kinds.

For the metal contained in the metal compound, Al, Mg, Ni, Zr, Ti, In, and Cr may be mentioned.

The metal compound is preferably an oxide or a hydroxide of the metal contained in the metal compound. For example, at least one selected from the group consisting of an aluminum oxide (Al₂O₃), a magnesium oxide (MgO), a nickel oxide (NiO), a zirconium oxide (ZrO₂), a titanium oxide (for example, TiO₂), an indium oxide (In₂O₃), and a chromium hydroxide (for example, Cr(OH)₃) is preferably used.

The leachable metal is contained in the positive electrode plate or the negative electrode plate, for example, as an element constituting the active material or as a conductive material. The leachable metal is leached out into the alkaline electrolyte, and deposited in the separator. The leachable metal forms a conductive path in the separator at this time. The conductive path causes an internal short-circuit, and becomes one of the causes of the decline in self discharge characteristics of alkaline storage batteries. The leachable metal includes, for example, Co and Mn.

In the present invention, the metal compound functions to allow the leachable metal that is leached out into the alkaline electrolyte to be deposited on the separator surface, the surface or inner positive electrode, or the surface or inner negative electrode by priority.

The metal compound has the above functions probably because of the following reasons.

When a metal compound is soluble to alkaline electrolytes, pH of the alkaline electrolyte decreases in the proximity of the separator surface, the positive electrode plate, or the negative electrode plate where the metal compound is included. Therefore, ions of the leachable metal are deposited on the separator surface, the surface or inside of the positive electrode plate, or the surface or inside of the negative electrode plate by priority. As a result, the deposition of the leachable metal into the separator is curbed. The metal compound soluble in alkaline electrolytes includes, for example, Al₂O₃.

When the metal compound is included in the negative electrode plate, the metal compound dissolved in the alkaline electrolyte causes a decrease in pH of the alkaline electrolyte in the proximity of the negative electrode plate. This is because dissolution of a metal derived from the metal compound involves consumption of OH⁻ ions (hydroxide ion). For example, the reaction of an aluminum oxide being dissolved in the alkaline electrolyte is as follows.

Al₂O₃+3H₂O→2Al(OH)₃

2Al(OH)₃+OH⁻→Al(OH)₄⁻→AlO₂⁻+2H₂O

Therefore, ions of the leachable metal being dissolved from the positive electrode plate and the negative electrode plate (for example, cobalt ion and manganese ion) are easily deposited on the negative electrode plate as an oxide. Therefore, deposition of the leachable metal in the separator is curbed, and the formation of the conductive path in the separator can be curbed.

Unlike the leachable metal, the metal derived from the metal compound dissolved in the alkaline electrolyte is not deposited in the separator. This is due to the fact that because alkaline electrolytes have a pH of 15 to 16 generally, a metal derived from the metal compound, for example, aluminum, is present in the state of AlO₂⁻ ions.

Similarly, when the positive electrode plate includes the metal compound, the metal compound dissolved in the alkaline electrolyte causes a decrease in pH of the alkaline electrolyte in the proximity of the positive electrode plate. Therefore, ions of the leachable metal are easily deposited on the positive electrode plate as an oxide. Therefore, deposition of the leachable metal in the separator is curbed, and formation of the conductive path in the separator can be curbed.

When the metal compound is insoluble in the alkaline electrolyte, the metal compound plays a key role in the deposition of the leachable metal by priority. Even though the metal compound is insoluble in the alkaline electrolyte, dissolution occurs slightly, and in the proximity of the metal compound, pH of the alkaline electrolyte decreases. Therefore, ions of the leachable metal are attracted to the proximity of the metal compound, to be deposited on the surface of the metal compound. As a result, deposition of the leachable metal into the separator is curbed. The metal compound insoluble in the alkaline electrolyte includes, for example, MgO.

The metal compound is preferably carried on at least one selected from the group consisting of the separator surface, the positive electrode plate surface, and the negative electrode plate surface.

When the metal compound forms a porous coated film on the negative electrode plate surface, the leachable metal leached out from the positive electrode plate and the negative electrode plate by priority is deposited to the negative electrode plate surface, not into the separator. The porous coated film containing the metal compound may be formed on only one side or on both sides of the negative electrode plate.

When the metal compound forms a porous coated film on the positive electrode plate surface, the leachable metal dissolved from the positive electrode plate and the negative electrode plate is deposited on the positive electrode plate surface by priority, not into the separator. The porous coated film containing the metal compound may be formed on only one side or on both sides of the positive electrode plate.

When the metal compound forms a porous coated film on the separator surface, the leachable metal dissolved from the positive electrode plate and the negative electrode plate is deposited on the separator surface by priority, not into the separator. The porous coated film containing the metal compound may be formed on only one side or on both sides of the separator.

Particularly, in view of the reduction of a resistance component for the positive electrode plate and the negative electrode plate, the porous coated film containing the metal compound is preferably formed on the separator surface. Also, the porous coated film formed on the surface of the negative electrode plate, having a larger area than the positive electrode plate, is more effective in preventing the entry of the leachable metal ion into the separator than the porous coated film formed on the positive electrode plate surface.

The porous coated film containing the metal compound includes the metal compound as an essential component, and includes a binder as a voluntary component. The method for forming the porous coated film containing the metal compound is not particularly limited. For example, the following may be carried out for the formation.

First, the metal compound, a binder, and a solvent are mixed to prepare a porous film paste. The porous coated film paste is applied on the face where the porous coated film is to be formed, and then dried, to form a porous coated film containing the metal compound. The method for applying the paste at that time is not particularly limited. The binder includes, for example, fluorocarbon resin, rubber resin, rubber particles, and acrylic resin without particular limitation. For the fluorocarbon resin, for example, polytetrafluoroethylene and polyvinylidene fluoride may be used. For the rubber resin, for example, modified acrylonitrile rubber may be used. For the rubber particles, for example, styrenebutadiene rubber may be used. For the acrylic resin, for example, modified polyacrylic acid may be used.

The amount of the binder included in the porous coated film containing the metal compound is, for example, 2 to 6 parts by weight per 100 parts by weight of the metal compound. The thickness of the porous coated film is preferably 2 to 6 μm, in view of the capture of the leachable metal and retardation of an increase in electrode plate resistance.

When the positive electrode contains the positive electrode material mixture or the negative electrode contains the negative electrode material mixture, the metal compound may be included in the positive electrode material mixture or the negative electrode material mixture. In this case as well, as in the case of forming the porous coated film, the formation of the conductive path because of the deposition of the leachable metal in the separator can be curbed. In view of simplification of manufacturing step of batteries, the metal compound is preferably included in the positive electrode material mixture or the negative electrode material mixture.

When the metal compound is included in the positive electrode material mixture, leaching of the leachable metal from the positive electrode plate is mainly curbed. This is because the leachable metal leached out from the positive electrode plate is deposited in the positive electrode plate by priority. The amount of the metal compound included in the positive electrode material mixture is preferably 1 to 8 parts by weight, and more preferably 4 to 6 parts by weight per 100 parts by weight of the positive electrode active material.

When the metal compound is included in the negative electrode material mixture layer, the leaching of the leachable metal from the negative electrode plate is curbed. This is because the leachable metal leached in the negative electrode is deposited in the negative electrode by priority. The amount of the metal compound included in the negative electrode material mixture is preferably 1 to 5 parts by weight, and more preferably 2 to 3 parts by weight per 100 parts by weight of the negative electrode active material.

The positive electrode plate is not particularly limited. For example, a conventionally known positive electrode plate may be used. The positive electrode plate includes sintered positive electrodes and paste positive electrodes. The sintered positive electrode is obtained by sintering the active material powder and the core material in a reducing atmosphere, at for example 800 to 1100° C. The paste positive electrode contains a positive electrode material mixture. The positive electrode material mixture contains, for example, a positive electrode active material, a binder, and a conductive material.

The positive electrode material mixture paste is obtained by mixing the positive electrode material mixture with a dispersion medium. The positive electrode plate is obtained by applying or charging the positive electrode material mixture paste on a core material such as a foamed nickel plate, and then drying. The positive electrode plate may be pressed to give a predetermined thickness, or may be cut to give a predetermined size. When the positive electrode material mixture contains the metal compound, the metal compound may further be added and mixed in, upon preparing the positive electrode material mixture paste. A thickener may also be mixed in the paste, as necessary.

The positive electrode active material is not particularly limited. For example, nickel oxyhydroxide, nickel hydroxide, a solid solution of nickel hydroxide, and a solid solution of nickel oxyhydroxide are used as the positive electrode active material. The solid solution contains, for example, cobalt and manganese, which are leachable metals.

The conductive material of the positive electrode is not particularly limited. For example, cobalt and a cobalt compound which are leachable metals are used as the conductive material. For the cobalt compound, cobalt hydroxide and cobalt oxyhydroxide are used. Preferably used is, for example, a composite material of an active material and a conductive material, in which the active material particles are covered with cobalt or a cobalt compound. The positive electrode binder is not particularly limited. For example, polytetrafluoroethylene is used as the binder.

The amount of the leachable metal contained in the positive electrode is generally about 3 to 10 parts by weight per 100 parts by weight of the positive electrode active material.

The negative electrode plate is not particularly limited. For example, a negative electrode material mixture paste is prepared by mixing a dispersion medium with a negative electrode material mixture containing a negative electrode active material, a binder, and a conductive material. A negative electrode plate is obtained by applying the negative electrode material mixture paste on a predetermined core material, and then drying. The negative electrode plate may be pressed to give a predetermined thickness, or may be cut to give a predetermined size. When the negative electrode material mixture contains the metal compound, the metal compound may further be added and then mixed, upon preparing the negative electrode material mixture paste. A thickener may be mixed with the paste, as necessary.

The negative electrode active material is not particularly limited. In the case of nickel-metal hydride storage batteries, for example, hydrogen storage alloys are used. In the case of nickel cadmium storage battery, for example, cadmium and a cadmium compound are used. In the case of nickel zinc storage batteries, zinc and a zinc compound are used.

For the hydrogen storage alloy to be used as the negative electrode active material of nickel-metal hydride storage batteries, for example, Mi_{3.55}Co_{0.75}Mn_{0.4}Al_{0.3}, and MmNi_{3.7}Co_{0.8}Mn_{0.4}Al_{0.3} (Mm is a mixture of rare-earth elements) may be mentioned. In this case, from the negative electrode, Co and Mn tend to be leached as the leachable metal.

The hydrogen storage alloy is preferably in a powder state. The average particle size of the hydrogen storage alloy powder is, for example, preferably 10 to 30 μm, more preferably about 15 μm.

The negative electrode binder is not particularly limited as well. For example, styrene-butadiene copolymers are used. The negative electrode conductive material is not particularly limited as well. For example, carbon black may be used.

The amount of the leachable metal contained in the negative electrode is generally about 10 to 30 parts by weight per 100 parts by weight of the negative electrode active material.

The alkaline electrolyte is not particularly limited, but generally an aqueous solution of potassium hydroxide may be mentioned. Potassium hydroxide is preferably included in the alkaline electrolyte by 10 to 30 wt %. The alkaline electrolyte may further contain lithium hydroxide and sodium hydroxide. Lithium hydroxide is preferably contained in the alkaline electrolyte by 1 to 5 wt %, and sodium hydroxide is preferably contained by 1 to 5 wt %.

For the separator, a sulfonated polyolefin nonwoven fabric may be used. For polyolefin, for example, polyethylene and polypropylene are used.

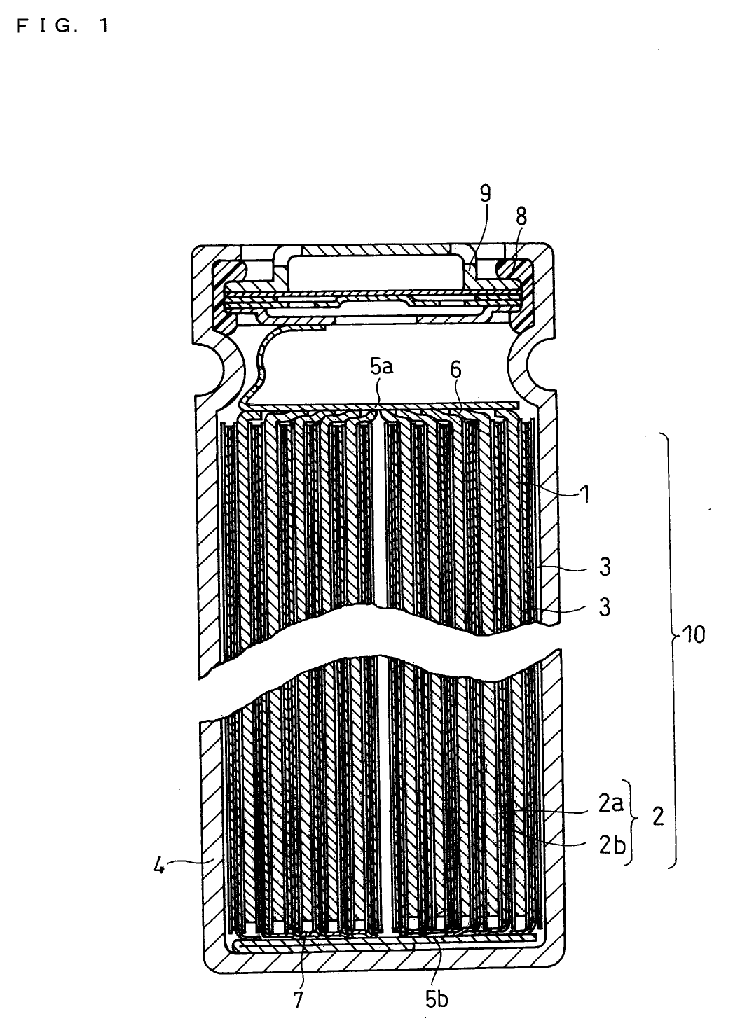

FIG. 1 is a vertical cross section of a cylindrical alkaline storage battery in one embodiment of the present invention. The alkaline storage battery includes an electrode assembly 10 obtained by stacking and wounding a positive electrode plate 1 and a negative electrode plate 2 with a separator 3 interposed therebetween. The positive electrode plate 1 includes, for example, in the case of the paste positive electrode, a positive electrode core material and a positive electrode material mixture charged thereon. The negative electrode plate 2 includes, for example, a negative electrode core material 2b, and a negative electrode material mixture layer 2a formed thereon. On top and bottom of the electrode assembly 10, an end portion 6 of the positive electrode and an end portion 7 of the negative electrode core material 2b are jutting out. To the end portions 6 and 7, plate-like positive electrode current collector 5a and negative electrode current collector 5b are connected, respectively. Afterwards, the electrode assembly 10 is inserted in a battery case 4, and the alkaline electrolyte is injected. Then, the opening of the battery case 4 is sealed with a sealing plate 9 with a gasket 8 at the periphery thereof. Lastly, the end portion of the opening of the battery case 4 is crimped to the gasket 8, thereby sealing the battery case 4. An alkaline storage battery is thus obtained.

In the following, the present invention is described in detail based on Examples and Comparative Examples. However, the present invention is not limited to Examples below.

### EXAMPLE 1

### (1) Positive Electrode Plate Preparation

A positive electrode material mixture paste was prepared by mixing a positive electrode material mixture including 100 parts by weight of nickel hydroxide particles, 7.0 parts by weight of cobalt hydroxide, 1.5 parts by weight of Yb₂O₃, 0.1 part by weight of carboxymethyl cellulose (CMC, a thickener), and 0.2 part by weight of polytetrafluoroethylene (PTFE, a binder), with an appropriate amount of pure water, i.e., a dispersion medium, to disperse the positive electrode material mixture in water. The positive electrode material mixture paste was charged to a formed nickel-made porous core material with a thickness of 1.4 mm, and then dried in a drier of 80° C. for 6 hours. Afterwards, the core material carrying the positive electrode material mixture was pressed with a roll press to give a thickness of about 0.7 mm, and then cut to a predetermined size, thereby making a positive electrode plate.

The obtained positive electrode plate contained cobalt as the leachable metal, and the amount of the leachable metal included in the positive electrode plate as a whole was about 7 parts by weight per 100 parts by weight of the positive electrode active material.

### (2) Negative Electrode Plate Preparation

For the negative electrode active material, a hydrogen storage alloy represented by MmNi_{3.55}Co_{0.75}Mn_{0.4}Al_{0.3} (Mm is a mixture of rare-earth elements) was used. The hydrogen storage alloy was made into a powder by crushing with a wet ball mill. The average particle size of the hydrogen storage alloy powder was about 15 μm. After stirring the hydrogen storage alloy powder in an aqueous solution of KOH at 80° C., a negative electrode material mixture containing 100 parts by weight of the hydrogen storage alloy powder, 0.15 part by weight of CMC, 0.3 part by weight of carbon black, and 0.8 part by weight of styrene-butadiene copolymer, was mixed with an appropriate amount of pure water, i.e., a dispersion medium, to disperse the negative electrode material mixture in water, thereby obtaining a negative electrode material mixture paste. The negative electrode material mixture paste was applied on both sides of a punched metal, i.e., a core material, and dried at 80° C. for 6 hours. Afterwards, it was pressed to give a predetermined thickness, and cut to give a predetermined size, thereby obtaining a negative electrode plate.

The obtained negative electrode plate contained cobalt and manganese as the leachable metal, and the amount of the leachable metal contained in the negative electrode as a whole was about 16 parts by weight per 100 parts by weight of the negative electrode active material.

### (3) Alkaline Electrolyte Preparation

KOH, LiOH, and NaOH were mixed with a molar ratio of 77:8:15, and the obtained mixture was dissolved in pure water, to prepare an alkaline electrolyte with a specific gravity of 1.26 g/cm³.

### (4) Porous Coated Film Formation

A porous film paste was prepared by mixing 97 parts by weight of Al₂O₃ with a median size of 0.3 μm (product name: AKP3000, manufactured by Sumitomo Chemical Co., Ltd.) as the metal compound, 37.5 parts by weight of an NMP solution containing 8 wt % of a modified acrylonitrile rubber (a binder, product name: BM-720H, manufactured by Zeon Corporation), and an appropriate amount of N-methyl-2-pyrrolidone (NMP), with a double-armed kneader. The porous film paste was applied on both sides of the negative electrode plate, and dried at 120° C. for an hour, to form a porous coated film with a thickness of 4 μm per side.

### (5) Cylindrical Battery Preparation

A cylindrical alkaline storage battery as shown in FIG. 1 was made.

First, the electrode assembly 10 was made by stacking and wounding the positive electrode plate 1 and the negative electrode plate 2 with the separator 3 interposed therebetween. On top and bottom of the electrode assembly 10, the end portion 6 of the positive electrode and the end portion 7 of the negative electrode core material 2b were allowed to jut out. For the separator 3, a sulfonated polypropylene nonwoven fabric was used. To the end portion 6 of the positive electrode and the end portion 7 of the negative electrode core material 2b that were allowed to jut out on top and bottom of the electrode assembly 10, the positive electrode current collector 5a and the negative electrode current collector 5b were welded, respectively. Afterwards, the electrode assembly 10 was inserted in the battery case 4. The positive electrode current collector 5a was connected to the rear side of the sealing plate 9, and the negative electrode current collector 5b was connected to the inner bottom face of the battery case 4. The battery case 4 had a cylindrical shape, with a diameter of 34 mm and a height of 61.5 mm (D size). Then, to the battery case 4, 5.2 ml of the alkaline electrolyte was injected. The opening of the battery case 4 was sealed with the sealing plate 9 having the gasket 8 at periphery thereof. The end portion of the opening of the battery case 4 was crimped to the gasket 8 to seal the battery case 4, thereby making a battery of Example 1. The designed capacity of the battery was set to 6000 mAh.

### EXAMPLE 2

A battery of Example 2 was made in the same manner as Example 1, except that the porous coated film containing Al₂O₃ was formed on both sides of the positive electrode plate instead of both sides of the negative electrode plate.

### EXAMPLE 3

A battery of Example 3 was made in the same manner as Example 1, except that the porous coated film containing Al₂O₃ was formed on both sides of the separator instead of both sides of the negative electrode plate.

### EXAMPLE 4

A battery of Example 4 was made in the same manner as Example 1, except that the porous coated film containing Al₂O₃ was not formed on both sides of the negative electrode plate, and Al₂O₃ powder was included in the negative electrode material mixture.

Upon preparing the negative electrode material mixture paste, to the negative electrode material mixture, 2 parts by weight of Al₂O₃ powder was added per 100 parts by weight of the hydrogen storage alloy.

### EXAMPLE 5

A battery of Example 5 was made in the same manner as Example 1, except that the porous coated film containing Al₂O₃ was not formed on both sides of the negative electrode plate, and Al₂O₃ powder was included in the positive electrode material mixture.

Upon preparing the positive electrode material mixture paste, to the positive electrode material mixture, 4 parts by weight of Al₂O₃ powder was added per 100 parts by weight of the active material particles containing nickel hydroxide.

### EXAMPLE 6

A battery of Example 6 was made in the same manner as Example 1, except that MgO was used instead of Al₂O₃ upon the porous coated film formation.

### EXAMPLE 7

A battery of Example 7 was made in the same manner as Example 2, except that MgO was used instead of Al₂O₃ upon the porous coated film formation.

### EXAMPLE 8

A battery of Example 8 was made in the same manner as Example 3, except that MgO was used instead of Al₂O₃ upon the porous coated film formation.

### COMPARATIVE EXAMPLE 1

A battery of Comparative Example 1 was made in the same manner as Example 1, except that the metal compound was not included in any of the separator surface, the positive electrode plate, and the negative electrode plate.

### COMPARATIVE EXAMPLE 2

A battery of Comparative Example 2 was made in the same manner as Comparative Example 1, except that the separator containing the alkali-resistant microporous film and the polyvinyl alcohol film as disclosed in Japanese Laid-Open Patent Publication No. 2006-73541 was used.

The separator containing the alkali-resistant microporous film and the polyvinyl alcohol film was made as in below.

First, 10 parts by weight of polyvinyl alcohol powder, 50 parts by weight of water, and nickel powder (average particle size of 15 μm) were mixed to prepare a paste. This paste was made into a film with a thickness of about 40 μm, and heated at a temperature of 180° C. for 10 minutes, to form an alkali-resistant microporous film (Ni film) (thickness of about 40 μm).

Then, the polyvinyl alcohol powder was homogenously dispersed in water to prepare a paste. This paste was made into a film with a thickness of 15 μm, and heated at a temperature of 180° C. for 10 minutes, to form a polyvinyl alcohol film (PVA film)(thickness of 15 μm). The polyvinyl alcohol film (PVA film) was made on one side of the alkali-resistant microporous film (Ni film). With the thus obtained Ni/PVA film, the Ni film was allowed to face the positive electrode plate, and the PVA film was allowed to face the negative electrode plate.

### TEST EXAMPLE 1

### Battery Evaluation

The batteries of Examples 1 to 8 and the batteries of Comparative Examples 1 to 2 were evaluated for self discharge characteristics after cycle test.

### (a) Cycle Test

The batteries of Examples 1 to 8 and the batteries of Comparative Examples 1 to 2 were charged at 20° C. for 6 hours with a charging current of 0.2 C, and discharged completely (discharged to 1.0 V) with a discharging current of 1 C. This cycle was repeated to a total of 300 cycles.

### (b) Self Discharge Test

The batteries of Examples 1 to 8 and the batteries of Comparative Examples 1 to 2 after the above cycle test were charged under an atmosphere of 20° C. for 36 minutes at a charging current of 1 C, until reaching SOC (State of Charge) of 60%. The charged battery was allowed to stand under an atmosphere of 45° C. for 14 days. Afterwards, under an atmosphere of 25° C., the batteries were discharged with a discharging current of 0.2 C until 1 V, and the remaining discharge capacity was measured. The results are shown in Table 1.

TABLE 1

| | | Metal Compound Position | | | Remained |
|---|---|---|---|---|---|
| | | Positive | Negative | | Discharge |
| | Metal | Electrode | Electrode | | Capacity |
| Battery | Compound | Plate | Plate | Separator | (%) |
| Ex. 1 | Al₂O₃ | — | Porous | — | 47 |
| | | | Coated | | |
| | | | Film | | |
| Ex. 2 | Al₂O₃ | Porous | — | — | 47 |
| | | Coated | | | |
| | | Film | | | |
| Ex. 3 | Al₂O₃ | — | — | Porous | 47 |
| | | | | Coated | |
| | | | | Film | |
| Ex. 4 | Al₂O₃ | — | Material | — | 46 |
| | | | Mixture | | |
| Ex. 5 | Al₂O₃ | Material | — | — | 46 |
| | | Mixture | | | |
| Ex. 6 | MgO | — | Porous | — | 47 |
| | | | Coated | | |
| | | | Film | | |
| Ex. 7 | MgO | Porous | — | — | 47 |
| | | Coated | | | |
| | | Film | | | |
| Ex. 8 | MgO | — | — | Porous | 47 |
| | | | | Coated | |
| | | | | Film | |
| Comp. | — | — | — | | 24 |
| Ex. 1 | | | | | |
| Comp. | — | — | — | Ni/PVA | 24 |
| Ex. 2 | | | | FILM | |

It was found that the remained discharge capacity in the batteries of Examples 1 to 8 was high, compared with the batteries of Comparative Examples 1 and 2. That is, the self-discharge amount decreased in the batteries of Examples 1 to 8, compared with the batteries of Comparative Examples 1 and 2.

In the battery of Example 1, the porous coated film including alumina is formed on both sides of the negative electrode plate. Alumina (the metal compound) included in the porous coated film is dissolved in the alkaline electrolyte. Therefore, in the proximity of the negative electrode plate, pH of the alkaline electrolyte is probably decreased. Based on this, the leachable metal leached out from the positive electrode plate and the negative electrode plate is deposited on the negative electrode plate surface by priority. Thus, the formation of the conductive path based on the deposition of the leachable metal into the separator is curbed. Therefore, the self-discharge amount is decreased.

In the battery of Example 2, the porous coated film containing alumina is formed on both sides of the positive electrode plate. Therefore, in the proximity of the positive electrode plate, pH of the alkaline electrolyte is decreased probably based on dissolution of alumina included in the porous coated film. Based on this, the leachable metal leached out from the positive electrode plate and the negative electrode plate is deposited to the positive electrode plate surface by priority. Thus, the formation of the conductive path in the separator is curbed.

In the battery of Example 3, the porous coated film including alumina is formed on the separator surface. Based on this, the leachable metal leached out from the positive electrode plate and the negative electrode plate is deposited to the separator surface by priority. Thus, the formation of the conductive path in the separator is curbed.

In the battery of Example 4, alumina is included in the negative electrode material mixture, instead of the porous coated film on both sides of the negative electrode plate. In this case as well, similarly to the battery of Example 1, the leachable metal leached out from the positive electrode plate and the negative electrode plate is deposited into the inner part of the negative electrode plate by priority. Thus, the formation of the conductive path in the separator is curbed.

In the battery of Example 5, alumina is included in the positive electrode material mixture, instead of the porous coated film on both sides of the positive electrode plate. In this case as well, similarly to the case of the battery of Example 2, the leachable metal leached out from the positive electrode plate and the negative electrode plate is deposited to the inner side of the positive electrode plate by priority. Therefore, the formation of the conductive path in the separator is curbed.

In the battery of Example 6, the porous coated film including magnesia is formed on the negative electrode plate surface. Magnesia is not dissolved in the alkaline electrolyte. However, the leachable metal leached out from the positive electrode plate and the negative electrode plate is deposited with magnesia as its core to the negative electrode plate surface by priority. Therefore, the formation of the conductive path in the separator is curbed.

In the battery of Example 7, the porous coated film including magnesia is formed on the positive electrode plate surface. In this case as well, similarly to the case of the battery in Example 6, the metal ion leached out from the positive electrode plate and the negative electrode plate is deposited with magnesia as its core to the positive electrode plate surface by priority. Therefore, the formation of the conductive path in the separator is curbed.

In the battery of Example 8, the porous coated film including magnesia is formed on the separator surface. In this case as well, similarly to the case of the battery of Example 6 and the battery of Example 7, the metal ion leached out from the positive electrode plate and the negative electrode plate is deposited with magnesia as its core to the separator surface by priority. Therefore, the formation of the conductive path in the separator is curbed.

Although the case where alumina or magnesia was used as the metal compound was described in the above Examples, the effects of the present invention were also confirmed as well in the case where nickel oxide, zirconia, titania, indium oxide, or chromium hydroxide was used.

Additionally, in the case where two or more of the metal compounds were used in combination as well, the effects of the present invention were confirmed.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An alkaline storage battery comprising:
a positive electrode plate;
a negative electrode plate;
a separator interposed between said positive electrode plate and said negative electrode plate; and
an alkaline electrolyte,
wherein at least one of said positive electrode plate and said negative electrode plate contains a metal capable of being leached out into said alkaline electrolyte,
at least one selected from the group consisting of a surface of said separator, said positive electrode plate, and
said negative electrode plate contains a metal compound, and said metal compound allows a metal leached out into said alkaline electrolyte from at least one of said positive electrode plate and said negative electrode plate to be deposited on said surface of said separator, a surface or inside of said positive electrode plate, or a surface or inside of said negative electrode plate.

2. The alkaline storage battery in accordance with claim 1, wherein said metal compound is at least one selected from the group consisting of an aluminum oxide, a magnesium oxide, a nickel oxide, a zirconium oxide, a titanium oxide, an indium oxide, and a chromium hydroxide.

3. The alkaline storage battery in accordance with claim 1, wherein said metal compound is carried on at least one of said surface of said positive electrode plate and said surface of said negative electrode plate.

4. The alkaline storage battery in accordance with claim 1, wherein said positive electrode plate includes a positive electrode material mixture, and said positive electrode material mixture contains said metal compound along with a positive electrode active material and a binder.

5. The alkaline storage battery in accordance with claim 1, wherein said negative electrode plate includes a negative electrode material mixture, and said negative electrode material mixture contains said metal compound along with a negative electrode active material and a binder.
